(19) United States
(12) Patent Application Publication
(10) Pub. No.: US 2024/0329216 A1
(43) Pub. Date: Oct. 3, 2024

(54) EXTERNAL ENVIRONMENT RECOGNITION APPARATUS AND METHOD FOR ADJUSTING PARAMETERS OF RECOGNITION ALGORITHM

(71) Applicant: TOYOTA JIDOSHA KABUSHIKI KAISHA, Toyota-shi Aichi-ken (JP)

(72) Inventors: Takuya MIGISHIMA, Hamamatsu-shi Shizuoka-ken (JP); Taichi KAWANAI, Susono-shi Shizuoka-ken (JP); Hiroshi SAKAMOTO, Susono-shi Shizuoka-ken (JP); Hayato ITO, Sunto-gun Shizuoka-ken (JP)

(73) Assignee: TOYOTA JIDOSHA KABUSHIKI KAISHA, Toyota-shi Aichi-ken (JP)

(21) Appl. No.: 18/614,820

(22) Filed: Mar. 25, 2024

(30) Foreign Application Priority Data
Mar. 27, 2023 (JP) 2023-050569

(51) Int. Cl. G01S 7/497; G01S 17/86; G01S 17/89; G01S 17/931

(52) U.S. Cl. CPC G01S 7/497; G01S 17/86; G01S 17/89; G01S 17/931

(57) ABSTRACT

The external recognition apparatus for an autonomous driving vehicle includes an external sensor, at least one processor, and at least one memory communicatively coupled to the at least one processor and storing executable a plurality of instructions. The plurality of instructions is configured to cause the at least one processor to estimate a self-location of an ego-vehicle, acquire registration information of a known stationary object associated with the self-location, acquire sensor information corresponding to the stationary object by the external sensor, and adjust a value of a specific parameter related to the sensor information among parameters of a recognition algorithm based on a deviation between the registration information and the sensor information.

### CROSS-REFERENCE TO RELATED APPLICATION

The present application claims priority under 35 U.S.C. § 119 to Japanese Patent Application No. 2023-050569, filed Mar. 27, 2023, the contents of which application are incorporated herein by reference in their entirety.

### BACKGROUND

### Field

The present disclosure relates to a technique for dynamically adjusting parameters of a recognition algorithm of an autonomous driving vehicle.

### Background Art

Examples of documents showing the technical level of the technical field related to the present disclosure include JP2021-528628A and JP2021-006797A. For example, JP2021-528628A discloses a recognition system for an autonomous driving vehicle, which specifies a sensor that has failed in recognition based on outputs of a plurality of types of sensors and lowers the reliability of the output of the sensor, thereby improving the recognition performance as a whole.

### SUMMARY

The recognition algorithm of the autonomous driving vehicle includes at least one parameter. The setting of parameters affects the recognition performance of the recognition algorithm. However, the recognition performance of the recognition algorithm depends on a recognition environment in which the autonomous driving vehicle is placed, and the recognition environment changes depending on sunlight conditions and weather conditions. To accommodate such changes in the recognition environment, the parameters need to be dynamically adjusted.

The present disclosure has been made in view of the above problem. An object of the present disclosure is to enable dynamic adjustment of parameters of a recognition algorithm of an autonomous driving vehicle to an optimal value according to a recognition environment.

The present disclosure provides an apparatus for achieving the above object. The apparatus of the present disclosure is an external environment recognition apparatus for an autonomous driving vehicle. The apparatus of the present disclosure includes an external sensor, at least one processor, and at least one memory communicatively coupled to the at least one processor and storing a plurality of executable instructions. The plurality of instructions is configured to cause at least one processor to execute the following processes. The first process is to estimate the self-location of the ego-vehicle. The second process is to acquire registration information of a known stationary object associated with the self-location. The third process is to acquire sensor information corresponding to the known stationary object of which the registration information is acquired by the second process, by the external sensor. The fourth process is to adjust a value of a specific parameter related to the sensor information among parameters of a recognition algorithm based on a deviation between the registered information and the sensor information on the same stationary object.

The present disclosure also provides a method for achieving the above object. The method of the present disclosure is a method for adjusting parameters of a recognition algorithm of an autonomous driving vehicle by an on-board computer. The method of the present disclosure includes the following steps. The first step is a step of estimating the self-location of the ego-vehicle. The second step is a step of acquiring registration information of a known stationary object associated with the self-location. The third step is a step of acquiring sensor information corresponding to the known stationary object of which the registration information is acquired in the second process, by an external sensor mounted on the ego-vehicle. The fourth step is a step of adjusting a value of a specific parameter related to the sensor information among the parameters of the recognition algorithm based on a deviation between the registered information and the sensor information on the same stationary object.

Furthermore, the present disclosure provides a program for achieving the above object. A program of the present disclosure is a program executable by an on-board computer of an autonomous driving vehicle. The program of the present disclosure is configured to cause the on-vehicle computer to execute the first to fourth processes described above. The program according to the present disclosure may be recorded in a non-transitory computer-readable storage medium.

According to the technique of the present disclosure, the sensor information obtained by the external sensor is evaluable with reference to the registration information of the known stationary object. Based on the evaluation, the parameter value of the recognition algorithm can be dynamically adjusted to an optimal value corresponding to the recognition environment.

### BRIEF DESCRIPTION OF THE DRAWINGS

FIG. 1 is a configuration diagram of an external environment recognition apparatus for an autonomous driving vehicle according to an embodiment of the present disclosure.

FIG. 2 is a flowchart illustrating a procedure of a method for adjusting parameters of a recognition algorithm according to the embodiment of the present disclosure.

FIG. 3A is a diagram for explaining a specific example of a method for adjusting the parameters of the recognition algorithm.

FIG. 3B is a diagram for explaining another specific example of a method for adjusting the parameters of the recognition algorithm.

FIG. 4A is a diagram for explaining a specific example of the method for adjusting the parameters of the recognition algorithm.

FIG. 4B is a diagram for explaining another specific example of the method for adjusting the parameters of the recognition algorithm.

FIG. 5A is a diagram for explaining a specific example of the method of adjusting the parameters of the recognition algorithm.

FIG. 5B is a diagram for explaining another specific example of the method of adjusting the parameters of the recognition algorithm.

FIG. 6A is a diagram for explaining a specific example of the method of adjusting the parameters of the recognition algorithm with a color histogram registered in a stationary object database.

FIG. 6B is a diagram for explaining another specific example of the method of adjusting the parameters of the recognition algorithm with a color histogram obtained with a camera.

### DETAILED DESCRIPTION

### 1. External Recognition Apparatus

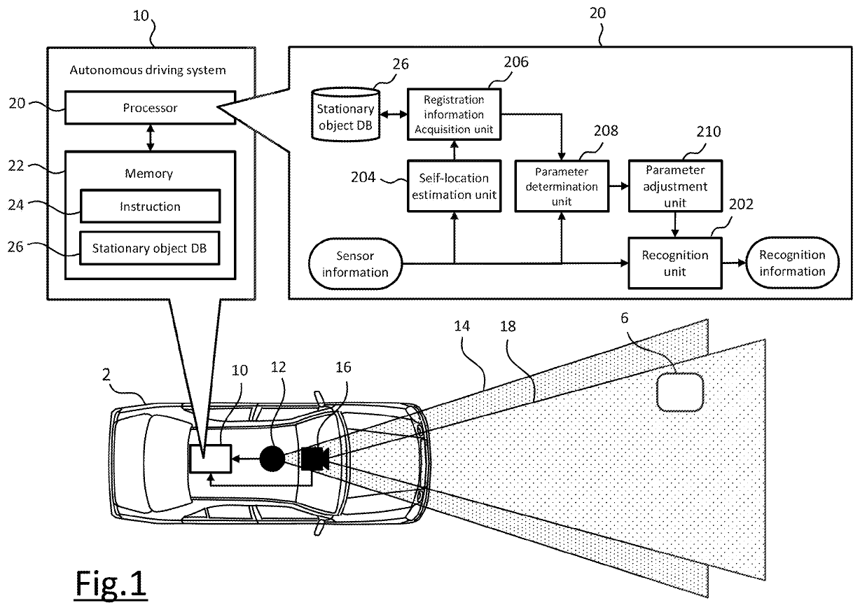

FIG. 1 is a diagram showing a configuration of an external environment recognition apparatus according to an embodiment of the present disclosure. The autonomous driving vehicle 2 to which the external environment recognition apparatus according to the embodiment of the present disclosure is applied is a vehicle capable of autonomous driving at level 2 or higher in the definition of the autonomous driving level of the SAE. Specifically, the autonomous driving vehicle 2 is a vehicle that can perform level 4 autonomous driving in an area where the traveling environment condition for level 4 autonomous driving is satisfied, and is a vehicle that can perform level 2 autonomous driving in other areas. Hereinafter, the autonomous driving vehicle 2 is simply referred to as a vehicle 2.

The vehicle 2 is equipped with an autonomous driving system 10. The autonomous driving system 10 is a system that performs three operations necessary for driving a vehicle, that is, recognition, determination, and operation, on behalf of a driver. The external environment recognition apparatus according to the embodiment of the present disclosure is an apparatus constituting a part of the autonomous driving system 10, and is configured to perform recognition among the three operations.

Sensor information obtained by an external sensor mounted on the vehicle 2 is used for recognition by the external recognition apparatus. The external sensor includes a Lidar 12 that scans the front of the vehicle 2 and a camera 16 that captures the front of the vehicle 2. The scanning range 14 of the Lidar 12 and the photographing range 18 of the camera 16 are at least partially overlapped. The Lidar 12 and the camera 16 are connected to the autonomous driving system 10 via an in-vehicle network. Further, a vehicular state sensor including an IMU and a GPS receiver are connected to the on-board network.

The autonomous driving system 10 is a computer including a processor 20 and a memory 22 communicatively coupled to the processor 20. The number of processors 20 and the number of memories 22 constituting the autonomous driving system 10 may be plural. The memory 22 is a computer-readable recording medium. The memory 22 stores a stationary object database (hereinafter, referred to as a stationary object DB) 26. The stationary object DB 26 is a database in which information on stationary objects on the map is registered. The stationary object mentioned here means an object that is constantly stationary, and an object that is temporarily present, such as a parked vehicle, is not included in the stationary object. Examples of such stationary objects include road signs, traffic lights, buildings, utility poles, and posts.

The memory 22 stores at least one program executable by the processor 20. The program comprises a plurality of instructions 24. The instructions 24 stored in the memory 22 include instructions for causing the processor 20 to operate as an external environment recognition apparatus. The processor 20 functions as a recognition unit 202, a self-location estimation unit 204, a registration information acquisition unit 206, a parameter determination unit 208, and a parameter adjustment unit 210 by executing these instructions. The functions of the respective units will be described below.

The recognition unit 202 recognizes a target existing around the vehicle 2 from the sensor information of the external sensor, and outputs information regarding the target as recognition information. The target to be recognized includes a moving object such as a preceding vehicle or a pedestrian and a stationary object 6 whose position is fixed on the map. A recognition algorithm obtained by machine learning is used for the recognition process by the recognition unit 202. The recognition algorithm can also be referred to as a recognition model. By processing the sensor information with the recognition algorithm, recognition information regarding the target included in the sensor information is obtained.

The recognition algorithm has a plurality of adjustable parameters. The optimal values of the parameters under a standard recognition environment are set in advance. However, the recognition environment in which the vehicle 2 is placed changes. Therefore, if the value of the parameter is fixed, the recognition performance of the recognition algorithm may be degraded depending on the change in the recognition environment. The self-location estimation unit 204, the registration information acquisition unit 206, the parameter determination unit 208, and the parameter adjustment unit 210 included in the processor 20 as the external recognition apparatus are functions for dynamically adjusting the parameters in accordance with a change in the recognition environment.

The self-location estimation unit 204 estimates the self-location of the vehicle 2. The self-location of the vehicle 2 can be estimated by using, for example, coordinates of the vehicle 2 acquired by the GPS receiver, an attitude of the vehicle 2 acquired by the IMU, sensor information acquired by the LiDAR 12 or the camera 16, and map information. Any self-location estimation method including a known method can be applied to the self-location estimation unit 204.

The registration information acquiring unit 206 acquires registration information of a known stationary object associated with the self-location from the stationary object DB 26. In the example illustrated in FIG. 1, the stationary object 6 is present in the LiDAR 12 and the recognition range of the camera 16. The registration information acquiring unit 206 searches for the stationary object DB 26 at the self-location of the vehicle 2, and thus the registration information of the stationary object 6 is acquired from the stationary object DB 26.

The registration information includes first type information which is information of the stationary object 6 itself and second type information which is information of the vehicle 2 with respect to the stationary object 6. The first type information includes distance-independent information that does not depend on the distance between the stationary object 6 and the vehicle 2 and distance-dependent information that depends on the distance between the stationary object 6 and the vehicle 2. Examples of the distance-independent information include the position, material, color, and volume of the stationary object 6. Examples of the distance-dependent information include the number of constituent points of the point cloud, the intensity, the accuracy of distances of the points, the gas likelihoods, and the number of constituent points of the noise point cloud when the external sensor is the LiDAR 12, and include the pixel values and the hues when the external sensor is the camera 16. The second type information is, for example, the position of the vehicle 2 and the position of the external sensor at which the point cloud of the stationary object 6 can be acquired, and the traveling speed of the vehicle 2.

The registration information is a value calculated logically or a statistical value calculated from past sensor information. Among the registered information, the distance-independent information is not affected by a change in the recognition environment such as weather, whereas at least a part of the distance-dependent information is affected by the change in the recognition environment. For example, when information acquired in rainy weather is compared with information acquired in fine weather, the number of constituent points of the point cloud decreases, the distance accuracy of each point deteriorates, and the number of constituent points of the noise point cloud increases. Therefore, depending on the recognition environment, a deviation occurs between the current sensor information and the registration information.

Each parameter of the recognition algorithm is optimized based on the registration information. Therefore, in a recognition environment in which a deviation occurs between the sensor information of the current external sensor and the registered information, it is possible to determine that the parameter related to the sensor information in which the deviation occurs is inappropriate. The parameter determination unit 208 acquires the current sensor information of the external sensor corresponding to the stationary object of which the registration information is acquired from the stationary object DB 26 by the registration information acquiring unit 206. In the example illustrated in FIG. 1, the sensor information corresponding to the stationary object 6 is acquired from the LiDAR 12 and the camera 16. The parameter determination unit 208 determines whether or not the value of the specific parameter related to the sensor information among the parameters of the recognition algorithm is appropriate based on the comparison result when the registration information and the sensor information are compared for each position of the vehicle 2.

When the parameter determining unit 208 determines that the value of the specific parameter is inappropriate, the parameter adjusting unit 210 adjusts the value of the specific parameter to an appropriate value. The adjustment method varies depending on the type of the specific parameter. The details of the adjustment method by the parameter adjustment unit 210 will be described later with a specific example.

### 2. Method for Adjusting Parameters of Recognition Algorithm

### 2-1. Overview

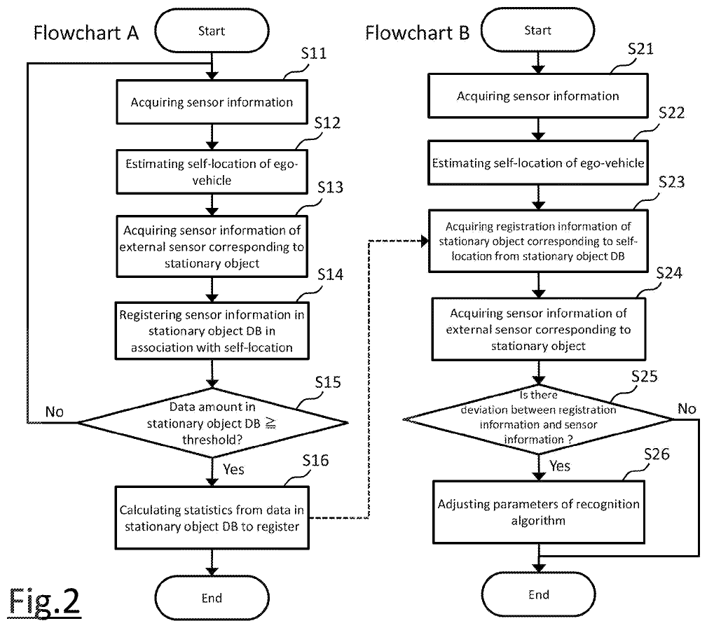

Next, a method of adjusting the parameters of the recognition algorithm by the processor 20 as the external environment recognition apparatus will be described. FIG. 2 is a flowchart showing the procedure of the method of adjusting the parameters of the recognition algorithm according to this embodiment. The flowchart A of the two flowcharts A and B shows a procedure for registering the registration information of the stationary object in the stationary object DB 26. The flowchart B shows a procedure for adjusting the parameters of the recognition algorithm by using the registration information of the stationary object registered in the stationary object DB 26.

First, the flowchart A will be described. In step S11, sensor information is acquired from various sensors connected to the autonomous driving system 10. Next, in step S12, the self-location of the vehicle 2 is estimated using at least a part of the sensor information acquired in step S11 and the map information. Next, in step S13, sensor information of the external sensor corresponding to the stationary object is acquired from the sensor information acquired in step S11.

Next, in step S14, the sensor information acquired in step S12 is associated with the self-location estimated in step S13, and the associated information is registered in the stationary object DB 26. Each time the vehicle 2 passes near a stationary object and is detected by the external sensor, the stationary object is accumulated in the stationary object DB 26. In step S15, it is determined whether the amount of information stored in the stationary object DB 26 is equal to or greater than a predetermined value.

If the amount of traffic has reached a certain value, the procedure proceeds to step S16. In step S16, a statistic of the stationary object is calculated from the stationary object DB 26. Then, the statistic is registered in the stationary object DB 26 as the registration information of the stationary object. For a stationary object whose amount of information has not reached the predetermined value, the processing from step S11 to step S15 is repeated until the amount of information becomes equal to or greater than the predetermined value.

Next, the flowchart B will be described. In step S21, sensor information is acquired from various sensors connected to the autonomous driving system 10. Next, in step S22, the self-location of the vehicle 2 is estimated using at least a part of the sensor information acquired in step S21 and the map information. In step S23, the registration information of the stationary object corresponding to the self-location estimated in step S22 is acquired from the stationary object DB 26. In step S24, sensor information of the external sensor corresponding to the stationary object of which the registration information is acquired in step S21 is acquired from the sensor information acquired in step S23.

In step S25, the registration information of the stationary object acquired from the stationary object DB 26 in step S23 is compared with the sensor information of the external sensor corresponding to the stationary object acquired in step S24. Then, it is determined whether or not there is a deviation between the registration information and the sensor information. When there is no deviation between the registration information and the sensor information, it can be determined that the parameters of the recognition algorithm are appropriate. In this case, the procedure is terminated without adjusting the parameters. On the other hand, when there is a deviation between the registration information and the sensor information, the procedure proceeds to step S26. In step S26, the value of a specific parameter related to the sensor information among the parameters of the recognition algorithm is adjusted.

The criterion and method for determining the presence or absence of the deviation differ depending on the contents of the registration information and sensor information to be compared. A specific example of a method for adjusting the parameters of the recognition algorithm will be described below.

### 2-2. First Specific Example

The first specific example is an example of a method of adjusting a parameter of a recognition algorithm for recognizing a target from point cloud information of the LiDAR 12. According to the recognition algorithm, clustering processing is performed on the point cloud obtained by the LiDAR 12, and each of the clusters of the point cloud obtained by the clustering processing is recognized as a target. In one example of the clustering process, first, each constituent point of the point cloud is regarded as a cluster consisting of one point, and the inter-cluster distance is calculated by the shortest distance method. Then, clusters having an inter-cluster distance equal to or less than a threshold value are connected as the same cluster, and the inter-cluster distance is calculated again for the connected clusters. Such processing is repeatedly performed, and the processing is ended at a point in time when the number of clusters finally does not change, and each of the clusters finally remaining is output as a target.

In the first specific example, a threshold value of the distance when the clusters are connected as the same cluster is used as a parameter of the recognition algorithm. The thresholds of distances, which are parameters of the recognition algorithm, are determined in advance according to the resolutions of the LiDAR 12. In the first example, the following values a and b are stored in the stationary object DB 26 as the registered information of the stationary object. These are sensor information related to the distance threshold, which is a parameter of the recognition algorithm.
a. The number nab of constituent points of the point cloud of the stationary object when the distance from the vehicle 2 to the stationary object is r
b. The position P (x, y, z) of each constituent point of the point cloud of the stationary object or a volume v_{db} of the stationary object in a coordinate system based on the vehicle 2 when the vehicle 2 is distant from the stationary object by r

The volume v_{db} may be measured from the real object. Further, when a set of positions of the respective constituent points of the point cloud of the stationary object is set as X, Y, and Z, and max (X) and min (X) are functions for calculating the maximum value and the minimum value of the matrix X, respectively, the volume v_{db} can also be calculated by the following Equation (1).

$$\\ \begin{matrix}{v}_{db} = ( max ( X ) - min ( X ) ) + ( max ( Y ) - min ( Y ) ) + ( max ( Z ) - min ( Z ) ) & ( 1 )\end{matrix}$$

By using the above values registered in the stationary object DB 26, the point cloud density d_{db} of the stationary object when the distances from the vehicle 2 to the stationary objects are r can be calculated by the following Equation (2).

$$\\ \begin{matrix}{d}_{db} = {n}_{db} / {v}_{db} . & ( 2 )\end{matrix}$$

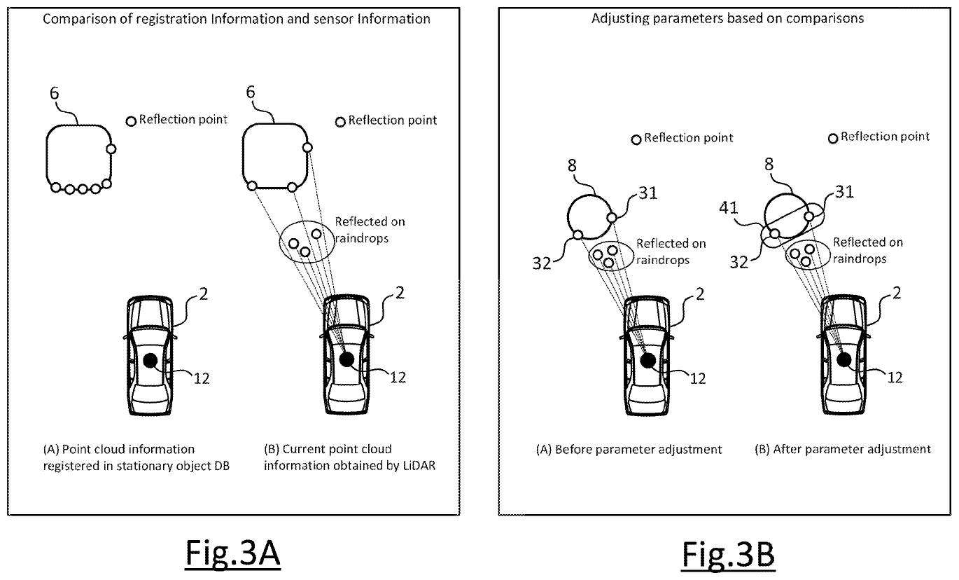

Here, a case where the LiDAR 12 is degraded by noise such as raindrops will be considered. In FIG. 3A, an image of point cloud information obtained when the stationary object 6 is scanned with LiDAR 12 is drawn. The image (A) in FIG. 3A is an image of the point cloud information registered in the stationary object DB 26. The image (B) in FIG. 3A is an image of the current point cloud information obtained in LiDAR 12. In the image (B), a raindrop exists between the stationary object 6 and the vehicle 2, and a part of the laser beam irradiated from the LiDAR 12 is reflected by the raindrop. Therefore, the number of reflection points of the LiDAR 12 obtained on the stationary object 6 is smaller than the number of reflection points registered in the stationary object DB 26. The point cloud density of the stationary object 6 is also reduced by the reduction in the number of reflection points, but the reduction in the point cloud density increases the distance between the constituent points of the point cloud, and thus, it is difficult to generate the cluster. If the cluster is not generated, the target cannot be obtained from the point cloud. Therefore, in order to reduce the number of undetected targets, it is necessary to increase the threshold value of the distance, which is a parameter of the recognition algorithm. On the other hand, if the threshold value of the distance is set to be larger than necessary, erroneous detection due to generation of unnecessary clusters is likely to occur.

In the first specific example, parameter adjustment according to the recognition environment is performed on the threshold value of the distance which is a parameter of the recognition algorithm based on determination using the following Equation (3). In the Equation (3), d is the current point cloud density of the stationary object 6 obtained from the output of the LiDAR 12. Threshold_{d} is a determination value for determining whether the parameter is appropriate or inappropriate.

$$\\ \begin{matrix}{d}_{db} - d > {Threshold}_{{}_{} d} . & ( 3 )\end{matrix}$$

When the relationship of the Equation (3) is satisfied, it is determined that the value of the parameter is inappropriate for the current recognition environment. In this case, a ratio d_{db}/d between the point cloud density d_{db} obtained from the registration information of the stationary object DB 26 and the current point cloud density d of the stationary object 6 is calculated as a coefficient. Then, the threshold of the distance, which is a parameter of the recognition algorithm, is multiplied by the coefficient d_{db}/d. As a result of such parameter adjustment, it is possible to suppress non-detection of the target in the rain.

In FIG. 3B, an image of a clustering result of a point cloud obtained when the pedestrian 8 is scanned in LiDAR 12 in the rain is drawn. The image (A) in FIG. 3B is an image of the clustering result before the parameter adjustment. The image (B) in FIG. 3B is an image of the clustering result after the parameter adjustment. In the image (A), a raindrop exists between the pedestrian 8 and the vehicle 2, and a part of the laser beam irradiated from the LiDAR 12 is reflected by the raindrop. Therefore, the point cloud densities of the reflection points of the LiDAR 12 obtained on the pedestrian 8 are small, and the distances between the reflection points 31 and 32 are large. In the image (A), the distance between the reflection points 31 and 32 is larger than the threshold value, and therefore the reflection points 31 and 32 are not connected, and a cluster corresponding to the pedestrian 8 is not generated. On the other hand, in the image (B) in FIG. 3B, the recognition environment is the same as that of the image (A), but the distances between the reflection points 31 and 32 are smaller than the thresholds by multiplying the thresholds of the distances as the parameters by the coefficient d_{db}/d. As a result, the reflection points 31 and 32 are connected to generate a cluster 41 corresponding to the pedestrian 8. This makes it possible to suppress the non-detection of the pedestrian 8 in the rain.

### 2-3. Second Specific Example

The second example is also an example of a method for adjusting a parameter of a recognition algorithm for recognizing a target from point cloud information of the LiDAR 12. The laser light emitted from the LiDAR 12 may be reflected by water vapor in the air or exhaust gas from preceding vehicle, which may cause erroneous detection. Therefore, a filter for removing noise is provided in the recognition algorithm. In the second specific example, the threshold value of the filter is used as a parameter of the recognition algorithm. In the second example, the following values a and b are stored in the stationary object DB 26 as the registered information of the stationary object. These are sensor information related to the threshold of the filter, which is a parameter of the recognition algorithm.
a. The number nab of constituent points of the point cloud of the stationary object when the distance from the vehicle 2 to the stationary object is r
b. The gas likelihood v_{db} of each constituent point of the point cloud of the stationary object when the distance from the vehicle 2 to the stationary object is r

According to the recognition algorithm, a filtering process is performed on the point cloud obtained by the LiDAR 12. In one example of the filtering process, when the relationship represented by the following Equation (4) is satisfied for a certain cluster, the cluster is determined to be a gas. In the Equation (4), n is the number of constituent points of the point cloud constituting the cluster, vi is a gas likeliness indicating the likeliness that the i-th constituent point is a gas, V is a mean value of gas likeliness of the entire cluster, and Thresholdᵥ is a filter threshold value for determining whether the target cluster is a gas. The threshold value of the filter, which is a parameter of the recognition algorithm, is adjusted in advance using the travel log.

$$\\ \begin{matrix}V = \frac{{\sum }_{i = 0}^{n} {v}_{i}}{n} > {Threshold}_{{}_{} v} . & ( 4 )\end{matrix}$$

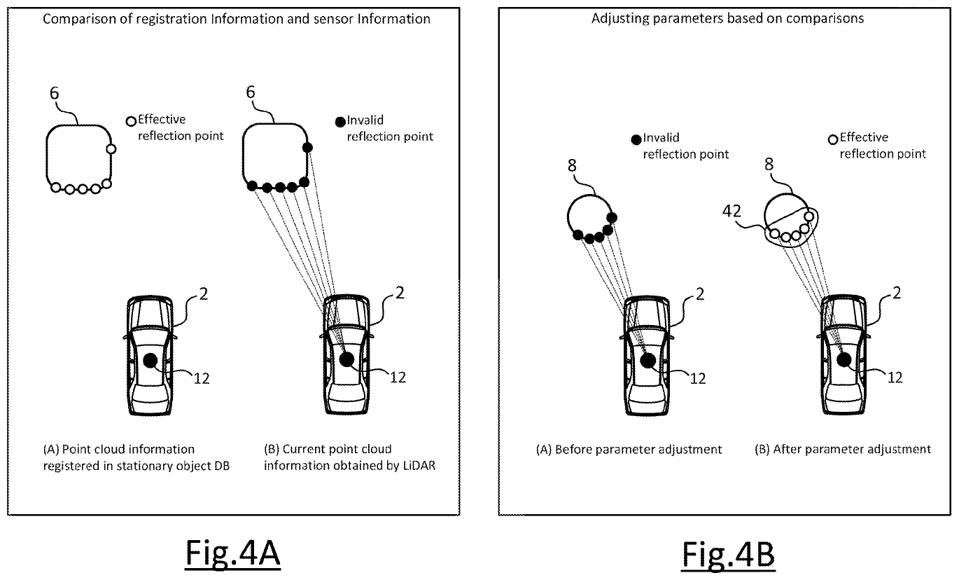

Here, a case where the gas likelihoods of the point cloud obtained from the output of the LiDAR 12 deviate from the original values will be considered. In FIG. 4A, an image of point cloud information obtained when the stationary object 6 is scanned with the LiDAR 12 is drawn. The image (A) in FIG. 4A is an image of the point cloud information registered in the stationary object DB 26. The image (B) in FIG. 4A is an image of the current point cloud information obtained by the LiDAR 12. In the image (B), the point cloud of the LiDAR 12 obtained on the stationary object 6 as a result of the filtering with the thresholds of the current gas likelihoods is treated as an invalid point cloud. As shown in the image (A), these point clouds are originally valid, and are registered as valid point clouds in the stationary object DB 26. However, clustering is not performed on the point cloud treated as invalid, and the target cannot be obtained from the point cloud unless a cluster is generated. Whether a reflection point with the LiDAR 12 is treated as invalid depends on the magnitude relationship between the gas likelihoods and the thresholds of the filters. Therefore, in order to reduce the number of undetected targets, it is necessary to adjust the threshold value of the filter of the recognition algorithm.

In the second specific example, the difference between the mean value V_{db} of the gas likelihoods of the constituent points of the point cloud of the stationary object 6 registered in the stationary object DB 26 and the mean value V of the gas likelihoods of the constituent points of the current point cloud of the stationary object 6 obtained from the output of the LiDAR 12 is calculated. Then, the threshold value of the filter of the recognition algorithm is corrected using the difference as a correction value.

In FIG. 4B, an image of a recognition result obtained when the pedestrian 8 is scanned by the LiDAR 12 in a situation where the gas likelihoods of the point cloud obtained from the output of the LiDAR 12 are deviated is drawn. The image (A) in FIG. 4B is an image of the recognition result before the parameter adjustment. The image (B) in FIG. 4B is an image of the recognition result after the parameter adjustment. In the image (A), as a result of the filtering based on the gas likelihoods, the point cloud of the LiDAR 12 obtained on the pedestrian 8 is determined to be an invalid point cloud. Since clustering is not performed on the invalid point cloud, a cluster corresponding to the pedestrian 8 is not generated, and the pedestrian 8 cannot be detected. On the other hand, in the image (B) in FIG. 4B, the recognition environment is the same as that of the image (A), but the thresholds of the filters of the recognition algorithm are corrected by the correction values. As a result of the correction, the point cloud of the LiDAR 12 obtained on the pedestrian 8 is determined to be a valid point cloud, and the cluster 42 corresponding to the pedestrian 8 is generated. Thus, even in a situation where the gas likelihoods of the point clouds obtained from the outputs of the LiDAR 12 deviate, it is possible to suppress the non-detection of the pedestrian 8.

### 2-4. Third Specific Example

The third example is also an example of a method of adjusting a parameter of a recognition algorithm for recognizing a target from point cloud information of the LiDAR 12. In the recognition algorithm, a future behavior is predicted for each moving object by using a behavior prediction model (the behavior prediction model itself is known at the time of filing of the present application). The prediction result by the behavior prediction model is represented by the probability density distribution of the future position of the reference point of the moving object. In the third example, the variance of the probability density distribution is used as a parameter of the recognition algorithm. In the third specific example, the following values a, b, and c are stored in the stationary object DB 26 as the registered information of the stationary object. These are sensor information related to the variance of the probability density distribution, which is a parameter of the recognition algorithm.
a. The distance rₜ from the vehicle 2 to the stationary object at time t
b. The standard deviation sₜ of the constituent points of the point cloud of the stationary object when the distance from the vehicle 2 to the stationary object is rₜ
c. The center position Cₜ of the point cloud of the stationary object when the distance from the vehicle 2 to the stationary object is rₜ

Here, a case where a point cloud is generated between the moving object and the vehicle 2 due to a raindrop will be considered. The point cloud between the moving object and the vehicle 2 is referred to as a noise point cloud. When the noise point cloud is close to the moving object, it is determined that the noise point cloud and the moving object belong to the same cluster in the clustering process using the recognition algorithm, and as a result, the recognized shape of the moving object changes as compared with the normal state. The recognition algorithm uses the positions of the cluster in the previous and current frames to estimate the velocity. Therefore, if the recognized shape changes and the center position changes, the speed of the moving object is erroneously estimated. From the above, it is considered that when a noise point cloud is generated near the moving object, the reliability of a speed estimation result by the recognition algorithm is reduced.

As described above, in the recognition algorithm, the future position of the moving object is represented by the probability density distribution. Since the probability density distribution is a region where the moving object is estimated to be likely to travel, when the reliability of the speed estimation is low, it is necessary to increase the probability density distribution as compared with the normal time in order to avoid contact between the moving object and the vehicle. The variance of the probability density distribution is a parameter for adjusting the range of the probability density distribution.

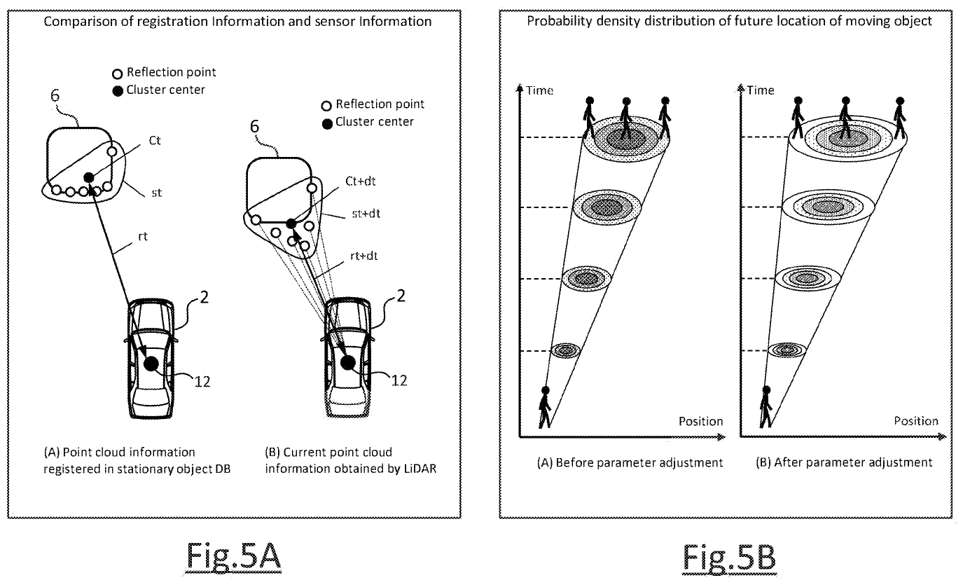

In FIG. 5A, an image of point cloud information obtained when the stationary object 6 is scanned with the LiDAR 12 is drawn. The image (A) in FIG. 5A is an image of the point cloud information registered in the stationary object DB 26. The image (B) in FIG. 5A is an image of the current point cloud information obtained by the LiDAR 12. As shown in the image (A), the center position Cₜ of the cluster of the stationary object 6, the standard deviation sₜ of the constituent points of the cluster of the stationary object 6, and the distance rₜ from the vehicle 2 to the stationary object 6 at the time t are registered as the registration information in the stationary object DB 26. The current time in the image (B) is a time t+dt after a time dt has elapsed from the time t. From the output of the LiDAR 12, the center position C_{t+dt} of the cluster of the stationary object 6 at the time t+dt, the standard deviations s_{t+dt} of the constituent points of the cluster of the stationary object 6, and the distances r_{t+dt} from the vehicle 2 to the stationary object 6 are acquired.

Here, d (Cₜ, C_{t+dt}) is a function for calculating the three dimensional distance between the center position Ct at time t and the center position C_{t+dt} at time t+dt, that is, the amount of change over time in the cluster center position between the previous and subsequent frames. The speed of the stationary object 6 in a normal state should be 0 km/h, but when the speed is erroneously estimated due to the noise point cloud, the time variation of the cluster center position between the previous and subsequent frames increases. The standard deviation of the points constituting the cluster is also larger than that in the normal state.

In the third specific example, the parameter adjustment is performed on the variance of the probability density distribution, which is a parameter of the recognition algorithm, according to the recognition environment based on the determination using the following Equations (5) and (6). Note that Threshold_{d}d in Equation (5) and Thresholds in Equation (6) are determination thresholds for determining whether the parameters are appropriate or inappropriate.

$$\\ \begin{matrix}d ( {C}_{t} , {C}_{t + dt} ) > {Threshold}_{{}_{} d} & ( 5 )\end{matrix}$$

$$\\ \begin{matrix}\vert {s}_{t} - {s}_{t + dt} \vert > {Threshold}_{{}_{} s} . & ( 6 )\end{matrix}$$

When both the relationships of Equations (5) and (6) are satisfied, it is determined that the value of the parameter is inappropriate for the current recognition environment. When the future position of the target is estimated by the recognition algorithm, probability density distribution in which the variance is widened by the speed errors between the previous and subsequent frames is used. By performing such parameter adjustment under a recognition environment in which a noise point cloud is generated, the effect described with reference to FIGS. 5A and 5B can be obtained.

In FIG. 5B, an image of probability density distribution of the future position of the moving object is drawn. The image (A) in FIG. 5B is an image of the probability density distribution before the parameter adjustment. The Image (B) in FIG. 5B is an image of the probability density distribution after parameter adjustment. The recognition environments of the image (A) and the image (B) are the same, but in the image (B), the probability density distribution of the future position of the moving object obtained by the recognition algorithm is increased by increasing the variance of the probability density distribution as the parameter. By increasing the probability density distribution in this way, for example, it is possible to prevent the contact between the moving object and the vehicle 2 due to the erroneous recognition of the speed.

### 2-5. Fourth Specific Example

The fourth specific example is an example of a method of adjusting a parameter of a recognition algorithm for recognizing a target from visual information of the camera 16. In the fourth specific example, the correction value of the hue of the HSV image obtained from the camera 16 is used as a parameter of the recognition algorithm. In the fourth example, the following values are stored in the stationary object DB 26 as the registered information of the stationary object. These are sensor information related to the correction value of the hue of the HSV image, which is a parameter of the recognition algorithm.
a. The position (xₘᵢₙ, xₘₐₓ, yₘᵢₙ, yₘₐₓ) of the stationary object when the distance from the vehicle 2 to the stationary object is r
b. The hue h of the stationary object when the distance from the vehicle 2 to the stationary object is r

As a method of detecting an object from the visual information of the camera 16, there are various methods such as template matching, key point matching, and a method of realizing them by machine learning. What can be said in common to all detection methods is that detection can be performed with high accuracy when an image given as prior knowledge and a current image are close to each other. Conversely, for example, when the color balance of the image is changed due to an abnormality of the camera 16 and a large deviation occurs between the image of the prior knowledge and the current image, it is assumed that the detection performance of the object is deteriorated.

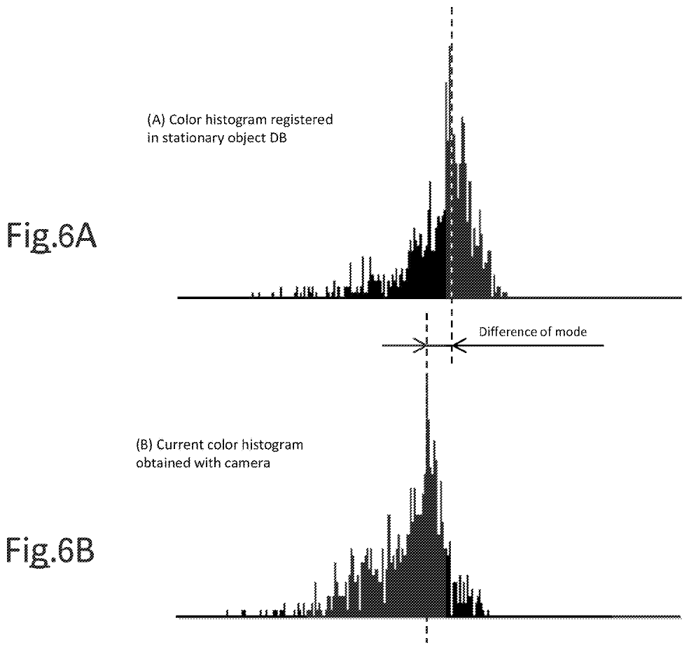

FIGS. 6A and 6B show a color histogram of the stationary object 6 obtained from the visual information of the camera 16. The color histogram in FIG. 6A is a color histogram of the stationary object 6 at a certain position acquired from the registration information registered in the stationary object DB 26. The color histogram FIG. 6B is a color histogram of the stationary object 6 at the same current position obtained by the camera 16. There is a difference in the mode value between the two color histograms. If the registration information of the stationary object DB 26 is used as a reference, the hue of the image of the camera 16 is corrected by the difference between the most frequent values of the two histograms, and thus it is possible to suppress a decrease in the detection capability of the object.

As a specific process, first, a process of converting an image of the camera 16 at a certain time into an HSV format and adding a predetermined value to the hue of the HSV image is added to the recognition algorithm. Next, the position of the stationary object 6 is acquired from the stationary objects DB 26 based on the self-location of the vehicle 2, and the pixels of the portion corresponding to the stationary object 6 are cut out from the image of the camera 16. Then, when the hue of the cut-out image is separated from the hue registered in the still object DB 26 by a predetermined value or more, the difference in hue is calculated, and the predetermined value set in the recognition algorithm is corrected by the difference. By such processing, it is possible to suppress a decrease in the object detection performance due to a change in the color balance of the image of the camera 16.

What is claimed is:

1. An external recognition apparatus for an autonomous driving vehicle, comprising:
an external sensor;
at least one processor; and
at least one memory communicatively coupled to the at least one processor and storing executable a plurality of instructions, the plurality of instructions being configured to cause the at least one processor to:
estimate a self-location of an ego-vehicle,
acquire registration information of a known stationary object associated with the self-location,
acquire sensor information corresponding to the stationary object by the external sensor, and
adjust a value of a specific parameter related to the sensor information among parameters of a recognition algorithm based on a deviation between the registration information and the sensor information.

2. The external environment recognition apparatus according to claim 1, wherein
the external sensor includes a LiDAR, and
the specific parameter includes at least one of
a threshold of a distance between points used for clustering a point cloud obtained by the LiDAR,
a threshold of gas likelihood used for determining whether the point cloud subjected to clustering is a gas, and
a variance of probability density distribution of future locations of the clustered point cloud.

3. The external environment recognition apparatus according to claim 1, wherein
the external sensor includes a camera, and
the specific parameter includes a correction value for a hue of an HSV image obtained by the camera.

4. A method for adjusting parameters of a recognition algorithm of an autonomous driving vehicle by an on-board computer, the method comprising:
estimating a self-location of an ego-vehicle;
acquiring registration information of a known stationary object associated with the self-location;
acquiring sensor information corresponding to the stationary object by an external sensor mounted on the ego-vehicle; and
adjusting a value of a specific parameter related to the sensor information among the parameters based on a deviation between the registration information and the sensor information.

5. A non-transitory computer-readable storage medium storing a program executable by an on-board computer of an autonomous driving vehicle, the program being configured to cause the on-board computer to:
estimate a self-location of an ego-vehicle;
acquire registration information of a known stationary object associated with the self-location;
acquire sensor information corresponding to the stationary object by an external sensor mounted on the ego-vehicle; and
adjust a value of a specific parameter related to the sensor information among parameters of a recognition algorithm based on a deviation between the registration information and the sensor information.
